(19) United States
(12) Patent Application Publication
(10) Pub. No.: US 2016/0226665 A1
(43) Pub. Date: Aug. 4, 2016

(54) METHOD FOR AUTHENTICATION OF AN OBJECT BY A DEVICE CAPABLE OF MUTUAL CONTACTLESS COMMUNICATION, CORRESPONDING SYSTEM AND OBJECT

(71) Applicant: STMICROELECTRONICS (ROUSSET) SAS, Rousset (FR)

(72) Inventor: Sylvie WUIDART, Pourrieres (FR)

(21) Appl. No.: 14/929,566

(22) Filed: Nov. 2, 2015

(30) Foreign Application Priority Data
Feb. 3, 2015 (FR) 1550827

(51) Int. Cl. H04L 9/30; H04L 9/08; H04W 12/02; H04L 9/00

(52) U.S. Cl. CPC H04L 9/3066; H04L 9/006; H04L 9/0861; H04W 12/02

(57) ABSTRACT

An object stores a signature associated therewith. An authentication method includes generating in the object at least one piece of personalized information of the object based on the stored signature and on at least one indication associated with the object, and communicating without contact by a device to the object during the authentication. The method also includes contactless communications to the device of the at least one piece of personalized information, determining by the device the signature based on at least the one piece of personalized information and on the at least one indication, and verifying the signature by the device.

### FIELD OF THE INVENTION

Embodiments of the invention and their implementation relate to contactless transmission between a reader, for example, a cellular mobile telephone emulated in a reader mode, and an object, for example, a transponder or tag, and more particularly, to the authentication of the object by the reader.

### BACKGROUND

Contactless or wireless communications take place between a reader and an object, for example, a transponder of the tag type, a contactless smart card or a mobile telephone emulated in a card mode. The reader may be a dedicated reader, for example, a fixed terminal, but also, for example, a mobile telephone emulated in a reader mode. These examples are not limiting.

Near field communication or NFC is a wireless connectivity technology which allows communications over a short distance, for example, 10 cm, between electronic devices such as, for example, contactless smartcards, transponders or mobile telephones emulated in a card mode, and readers. NFC technology is particularly well adapted for connecting any type of user device and allows fast and easy communications.

A contactless object is an object capable of exchanging information via an antenna with another contactless object, for example, a reader, according to a contactless communications protocol. An NFC object, which is a contactless object, is an object that is compatible with NFC technology.

NFC technology is an open technology platform standardized in the standards ISO/IEC 18092 and ISO/IEC 21481 but incorporates numerous already existing standards such as, for example, the type A and type B protocols defined in the standard ISO-14443. These are communications protocols that can be used in NFC technology.

When information is transmitted between a reader and an object emulated in a tag or card mode, the reader generates a magnetic field by its antenna which is generally, in the standards conventionally used, at a frequency of 13.56 MHz.

On the other side, the antenna of the object emulating the tag modulates the field generated by the reader. This modulation is carried out by modifying the load connected to the terminals of the antenna of the object.

By modifying the load across the terminals of the antenna of the object, the output impedance of the antenna of the reader changes due to the magnetic coupling between the two antennas. This results in a change in the amplitudes and/or the phases of the voltages and currents present on the antennas of the reader and of the object. Accordingly, in this way, the information to be transmitted from the object to the reader is transmitted via load modulation to the antenna current of the reader.

The objects such as, for example, contactless transponders, are used in numerous applications such as, for example, mobile ticketing in public transportation or the tracking of products in transportation applications (tracking of baggage, for example) or furthermore, in the field of finance (contactless payment) or in the field of access control to buildings.

It is important, at least for certain applications considered as particularly sensitive, that the object can be authenticated to avoid, as far as possible, the use of cloned objects produced by third parties with harmful intentions.

The European patent application no. 2,677,473 describes a method for authentication of a tag or transponder. This method includes the generation of a signature stored in a memory of the transponder. This signature is obtained by using the private key of an asymmetric encryption/decryption algorithm, for example, the RSA algorithm.

To carry out the authentication, the signature and the identifier of the transponder are communicated to the device which decrypts the signature with the aid of the public key of the asymmetric decryption algorithm in such a manner as to obtain the identifier of the transponder which is verified with the identifier communicated. Such a method nevertheless is vulnerable with respect to a third party with harmful intentions.

Indeed, the public key, the identifier of the transponder, together with the signature, are public data values accessible unencrypted. As a consequence, a third party with harmful intentions can incorporate into a conventional memory equipped with an NFC interface the identifier of the transponder, together with the signature, and duplicate this memory a very large number of times in a very large number of cloned transponders.

It will then be noticed that these transponders are not original transponders if, for example, several transponders having the same identifier communicate with cellular mobile telephones at geographically different locations. One approach for detecting these cloned devices includes detecting them by an entity for verifying or monitoring the presence of a very large number of transponders having the same identifier, and then the establishment of lists of identifiers to be blocked.

### SUMMARY

According to one embodiment and its implementation, a more robust and less vulnerable authentication is provided for an object, for example, a transponder, capable of contactless communications with a device which acts as an authenticator device. Such a less vulnerable authentication may be carried out at a lower cost while at the same time making it very difficult to fabricate cloned objects using a simple memory by a third party with harmful intentions.

According to one aspect, a method is provided for authentication of an object by a device, with the object storing a signature associated with the object. The method comprises generation within the object of at least one piece of information for personalization of the object using at least the stored signature, and at least one indication associated with the object and communicated without contact by the device to the object during the authentication. The method may further comprise a contactless communications to the device of the at least one piece of personalized information, at least one determination by the device of the signature based on at least the one piece of personalized information and on the at least one indication, and at least one verification of the signature by the device.

Thus, during the authentication, at least one personalization of the signature stored in the object may be carried out upon the initiative of the device and within the object. The at least one personalized signature may be subsequently transmitted to the device, which allows the device, having knowledge of this or of these personalization(s), to extract the signature from it to carry out at least once the verification of this signature.

This therefore makes it very difficult to use a simple memory by a third party with harmful intentions for cloning the object. It would cause this third party with harmful intentions to provide a specific electronic circuit comprising, for example, an FPGA component or a microcontroller in order to clone the object. This would not be cost effective for the third party.

In such a manner as to render the personalization of the object even more secure, the at least one indication may advantageously be generated by the device during the authentication.

Furthermore, the generation of this indication advantageously may comprise generation of an unpredictable variable, for example, a pseudo-random or random number. This renders the authentication even more robust and, in particular, allows a device to potentially be able to authenticate several times the same object with different personalizations at each authentication request.

One way of rendering the authentication even more robust is to insert redundancy into the personalization of the stored signature. Such redundancy may, for example, be obtained by using several (at least two) different indications associated with the object which will lead to the generation of several (at least two) pieces of personalized information.

Moreover, by way of a non-limiting example, the use of an unpredictable variable as indication is particularly well adapted for the generation of different indications. This is because two unpredictable variables generated successively have a very high probability of being different.

Thus, the method may comprise generation within the object of several pieces of personalized information for the object based on the stored signature, and on several different indications associated with the object and communicated without contact by the device to the object during the authentication. The method may further comprise contactless communications to the device of the several pieces of personalized information, and several determinations by the device of the signature respectively using the several pieces of personalized information and the corresponding indications.

At this stage, several approaches exist for ending the authentication, which could be chosen depending on the application envisaged and/or on the processing power available in the device.

Thus, the at least one verification of the signature by the device may comprise a pre-verification of the equality of the signatures determined, and in the case of equality, a verification of one of the signatures determined. If the verification step leads to an inequality, the object may then be declared as non-authenticated without it being necessary to verify the signature.

As a variation, the at least one verification of the signature by the device may comprise a verification of each of the signatures determined. In this case, the object may be able to be declared as authenticated if all these verifications of the signature have been positive.

The generation of the at least one piece of personalized information may comprise at least one masking of the signature by a masking operator using the at least one indication. The at least one determination by the device of the signature may comprise at least one de-masking of the at least one masked signature, by the de-masking operator associated with the masking operator and of the at least one indication.

The notion of masking is a very wide notion which may incorporate encryption by an encryption algorithm, for example, of the DES or AES type, but also, in a much simpler and much more cost-effective manner, a scrambling operator, or even more simply a logical operator of the EXCLUSIVE OR type.

The stored signature may result from an encryption of at least one object-identifier of the object with a private key of an asymmetric encryption/decryption algorithm. The at least one verification of the signature may comprise a decryption by the device of the at least one encrypted object-identifier, by the public key of the encryption/decryption algorithm. A comparison is made of the result of the decryption with the at least one object-identifier having been communicated to the device by the object.

The generation of the pair of public and private keys, making the public key available to the device, the generation of the signature and its storage in the object may be carried out in a third-party entity, for example, but in a non-limiting manner, during the fabrication of the object.

As a variation, it may also be possible for the signature to comprise an encryption not only of the object-identifier but also of a device-identifier associated with the device, with the private key of the asymmetric encryption/decryption algorithm.

In this case, the at least one verification of the signature may comprise the decryption by the device of the object-identifier and of the device-identifier encrypted by the public key and a comparison of the result of the encryption not only with the object-identifier which has been communicated without contact to the device by the object, but also with the device-identifier.

The object is, for example, an NFC object and the device can be a device comprising at least one NFC functionality, for example, a cellular mobile telephone equipped with NFC functionality.

The exchanges between the object and the device for the generation of the personalized information and its communications may advantageously be carried out by messages having a format conforming to the NFC Data Exchange Format-NDEF specification.

So as not to generate specific commands, the contactless communications of the at least one indication by the device to the object and the contactless communications of the at least one piece of personalized information by the object to the device comprises commands for writing and reading the object-identifier in which the contents of the fields dedicated to the object identifier may be modified in order to contain the at least one indication or the at least one piece of personalized information.

Furthermore, whether these modifications are taken into account by the object may be conditioned to a chosen value of a parameter, which value may be fixed by the device.

According to another aspect, a system is provided comprising an object and a device capable of contactless communications, with the object comprising memory means or a memory configured for storing a signature associated with the object and object-processing means or an object-processor configured for carrying out, upon the initiative of the device, at least one personalization of the stored signature, and for communicating to the device the at least one personalised signature. The device may comprise device-processing means or a device-processor configured for extracting the signature from this or these personalised signatures, and for carrying out at least once the verification of this signature.

The device-processing means may be configured for communicating to the object at least one indication associated with the object during an authentication of the object by the device. The object-processing means may be configured for generating at least one piece of personalized information for the object based on at least the stored signature and on the at least one indication and delivering the at least one piece of personalized information to the device. The device-processing means may be furthermore configured for carrying out at least one determination of the signature based on at least the one piece of personalized information and on the at least one indication and carrying out at least one verification of the signature.

The device-processing means may comprise a generator configured for generating the at least one indication during the authentication. The generator may comprise a pseudo-random or random numbers generator, with the at least one indication comprising a pseudo-random or random number.

The device-processing means may be configured for communicating to the object several different indications associated with the object during an authentication of the object by the device. The object-processing means may be configured for generating several pieces of personalized information for the object based on the stored signature and on the several different indications, and delivering these pieces of personalized information to the device. The device-processing means may be furthermore configured for performing several determinations of the signature (SGN) respectively using the several pieces of personalized information and the corresponding indications.

The device-processing means may be configured for carrying out a pre-verification of the equality of the signatures determined, and in the case of equality, a verification of one of the signatures determined. The device-processing means may be configured for carrying out a verification of each of the signatures determined.

The object-processing means may comprise a masking operator configured for carrying out at least one masking of the signature using the indication so as to generate the at least one piece of personalized information. The device-processing means may comprise a de-masking operator associated with the masking operator configured for carrying out at least one de-masking of the at least one masked signature by the at least one indication so as to carry out at least one determination of the signature.

The stored signature may result from an encryption of at least one object-identifier of the object with a private key of an asymmetric encryption/decryption algorithm. The object-processing means may be configured for communicating to the device the at least one object-identifier. The device-processing means may comprise means of verification of the signature comprising the encryption/decryption algorithm capable of carrying out a decryption of the at least one encrypted object-identifier by the public key, and comparison means or a comparator designed to carry out a comparison of the result of the decryption with the at least one object-identifier having been communicated to the device by the object.

The system may furthermore comprise a third-party entity capable of generating the pair of public and private keys, making the public key available to the device, generating the signature and storing it in the object.

The third-party entity may be configured for generating the signature by an encryption of the object-identifier and of a device-identifier associated with the device with the private key of the asymmetric encryption/decryption algorithm. The encryption/decryption algorithm of the means of verification may be capable of decrypting the object-identifier and the encrypted device-identifier by the public key. The comparison means may be designed to carry out a comparison of the result of the decryption with the device-identifier, and with the object-identifier having been communicated to the device by the object.

According to one embodiment, the memory means of the object may furthermore be configured for storing a parameter. The device-processing means may be configured for generating commands for writing and reading the object-identifier in which the contents of the fields dedicated to the object-identifier are modified so as to contain the at least one indication or the at least one piece of personalized information, and for fixing the value of the parameter to a chosen value. The object-processing means may be configured so as to take into account the modifications of the contents of the fields when the value of the parameter has the chosen value.

According to another aspect, a device is also provided belonging to the system as defined above.

According to yet another aspect, an object is provided belonging to the system as defined above.

According to yet another aspect, an object is provided capable of contactless communications with a device comprising memory means configured for storing a signature associated with the object, object-processing means configured for generating at least one piece of personalized information for the object based on at least the stored signature and at least one indication associated with the object communicated by the device to the object during an authentication of the object by the device, and delivering the at least one piece of personalized information to the device.

The object-processing means as defined above may comprise a masking operator configured for carrying out at least one masking of the signature using the at least one indication so as to generate the at least one piece of personalized information.

The stored signature results from an encryption of at least one object-identifier of the object with a private key of an asymmetric encryption/decryption algorithm, and the object-processing means may be configured for communicating to the device the at least one object-identifier.

The object may be a transponder or else, more generally, an NFC object. The object may be configured for exchanging messages having a format conforming to the NFC Data Exchange Format-NDEF specification during the generation of the personalized information and of its communications.

The memory means of the object may furthermore be configured for storing a parameter. The object-processing means may be configured for receiving commands for writing and reading the object-identifier in which the contents of the fields dedicated to the object-identifier are modified so as to contain the at least one indication or the at least one piece of personalized information, and so as to take into account the modifications of the contents of the fields when the value of the parameter has a chosen value.

### BRIEF DESCRIPTION OF THE DRAWINGS

Other advantages and features of the invention will become apparent upon examining the detailed description of non-limiting embodiments and their implementation and the appended drawings in which:

FIGS. 1 to 13 illustrate schematically various embodiments of the invention and their implementation.

### DETAILED DESCRIPTION

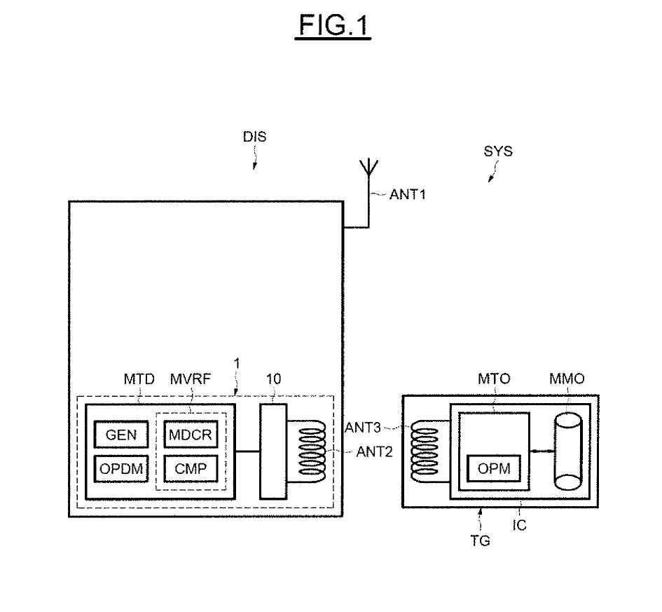

In FIG. 1, the reference SYS denotes a system comprising a device DIS, for example, a cellular mobile telephone, and an object TG, for example, a transponder. With the device DIS configured as a cellular mobile telephone, it is equipped with an antenna ANTI for the establishment of telephone communications.

The device DIS furthermore comprises a block 1 having NFC functionality and comprising an antenna ANT2, for example, an inductive antenna, used for contactless communications with the transponder TG.

The block 1 also comprises a transmitter/receiver device 10 or transmitter/receiver head, with a conventional structure which comprises means or circuitry for modulation/demodulation of frames, a frame controller designed to calculate parity bits according to a predefined logical function, for example, as defined in the standard ISO 14443.

The transmitter/receiver head 10 is connected via a bus to a host microcontroller, for example, a microcontroller NFC comprising, for example, a conventional central processing unit associated with various memories.

The microcontroller incorporates device-processing means or a device-processor MTD which comprises a generator GEN of pseudo-random numbers, a de-masking operator OPDM, and signature verification means or signature verification circuitry MVRF including decryption means or decryption circuitry MDCR and a comparator CMP. The functionality of these various items will be considered in more detail below.

The object or transponder TG, for its part, comprises an antenna ANT3 designed to be magnetically coupled with the antenna ANT2 for the contactless communications. This antenna ANT3 is connected to an integrated circuit IC comprising object-processing means or an object-processor MTO, together with memory means or a memory MMO. The object-processing means comprise a masking operator OPM whose functionality will be considered in more detail below.

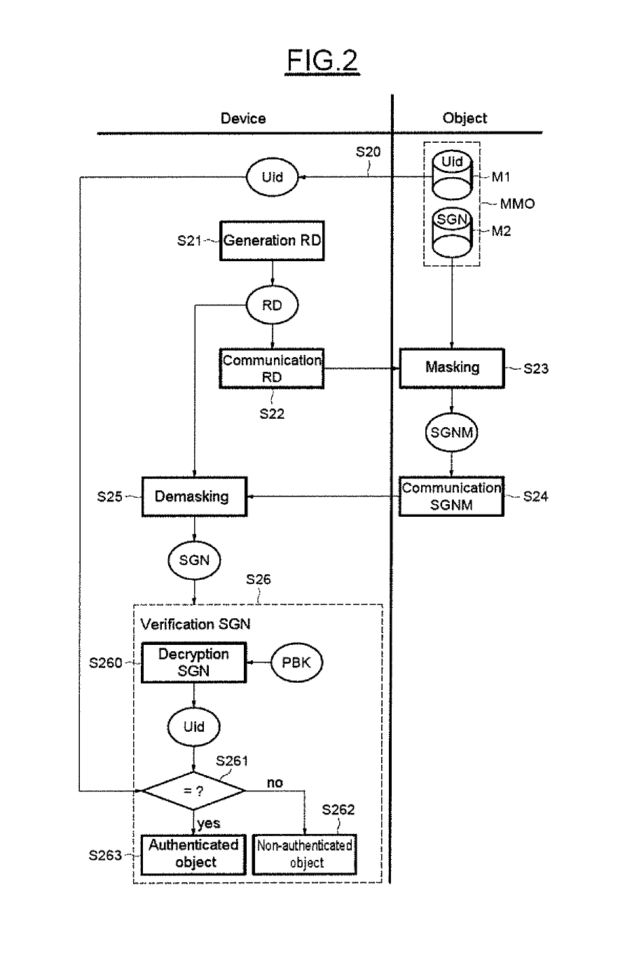

Reference is now more particularly made to FIG. 2 in order to illustrate one embodiment of a method for authentication of the object TG by the authenticator device DIS. The memory means MMO of the object comprise a first memory M1 storing an object-identifier Uid and a second memory M2, for example, but not necessarily a protected memory, storing a signature SGN associated with the object. The generation of this signature will be considered in more detail below. However, it may now already be said that the signature SGN is connected to the object-identifier Uid.

During an identification, the object-identifier Uid is transmitted by the object to the device (step S20) which stores this object-identifier in a register, for example. The generator GEN of the device then generates, in a step S21, an indication RD associated with the object, which is in the present case a pseudo-random number RD. This indication RD is communicated (step S22) by the device to the object.

The masking operator OPM of the object-processing means then carries out a masking of the signature SGN using the indication RD, so as to supply a masked signature SGNM. This masked signature SGNM is communicated (step S24) to the device-processing means.

The de-masking operator OPDM, associated with the masking operator OPM then carries out a de-masking of the masked signature SGNM using the indication RD, so as to obtain the signature SGN.

The verification means or verification circuitry MVRF will subsequently verify (step S26) the signature SGN which has been de-masked. For this purpose, as will be seen in more detail below, one way of obtaining the signature SGN is to use an encryption of the identifier Uid with a private key of an asymmetric encryption/decryption algorithm, for example, but not limited to an algorithm of the RSA type.

The device-processing means MTD therefore decrypt the signature SGN by the public key PSK associated with the private key. This decryption allows the object-identifier Uid to be obtained which is compared by the comparator CMP, in a step S261, with the object-identifier Uid stored in the register and which had been communicated in the step S20 by the object.

If the two identifiers-object coincide, then the object is considered as having been authenticated (step S263). In the opposite case, the object is non-authenticated (S262).

The masking operator OPM and the associated de-masking operator could be a symmetric encryption/decryption algorithm, for example, an algorithm of the AES or DES type.

The masking operator may be configured to carry out a scrambling of the bits of the signature SGN with the bits of the pseudo-random number RD according to a predefined scrambling rule. In this case, the de-masking operator could be an inverse operator of the scrambling operator configured to carry out a descrambling of the masked signature SGNM with the pseudo-random number RD according to the same descrambling rule as the scrambling rule used.

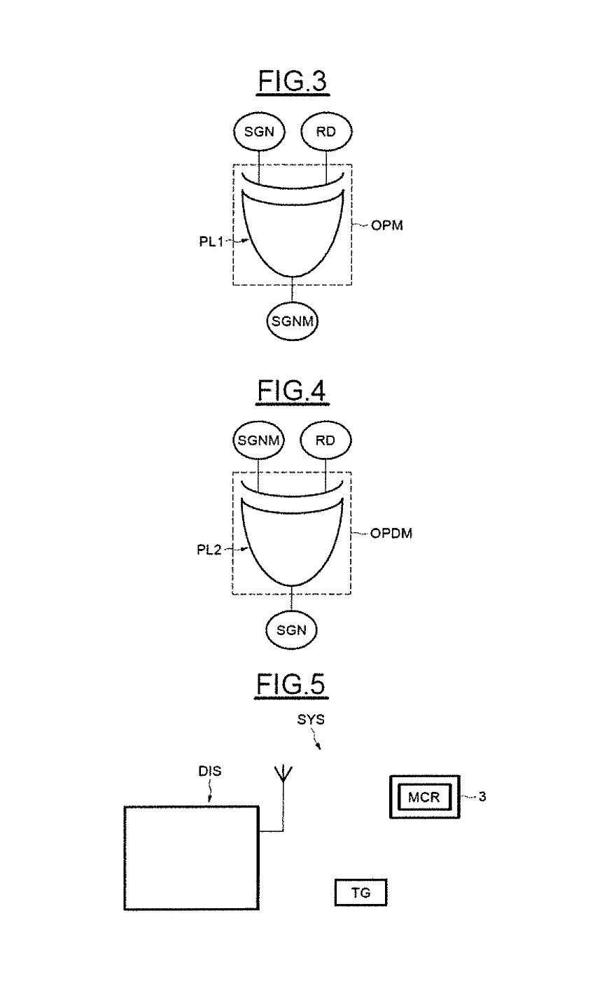

However, one particularly simple and low-cost way of carrying out the masking S23 and the de-masking S25 in FIG. 2 includes using an EXCLUSIF OR logic gate PL1 as a masking operator OPM (FIG. 3), receiving the signature SGN on one input and, on the other input, the pseudo-random number RD and supplying at the output the masked signature SGNM.

In this case, as illustrated in FIG. 4, the de-masking operator OPDM comprises an EXCLUSIVE OR logic gate PL2 receiving the masked signature SGNM on one of its inputs and, on the other input, the pseudo-random name RD. The output of the logic gate PL2 supplies the signature SGN.

As illustrated in FIG. 5, the system SYS may furthermore comprise a third-party entity 3, for example, a transponder manager, comprising encryption means or encryption circuitry MCR using the aforementioned asymmetric encryption/decryption algorithm, for example, the algorithm of the RSA type.

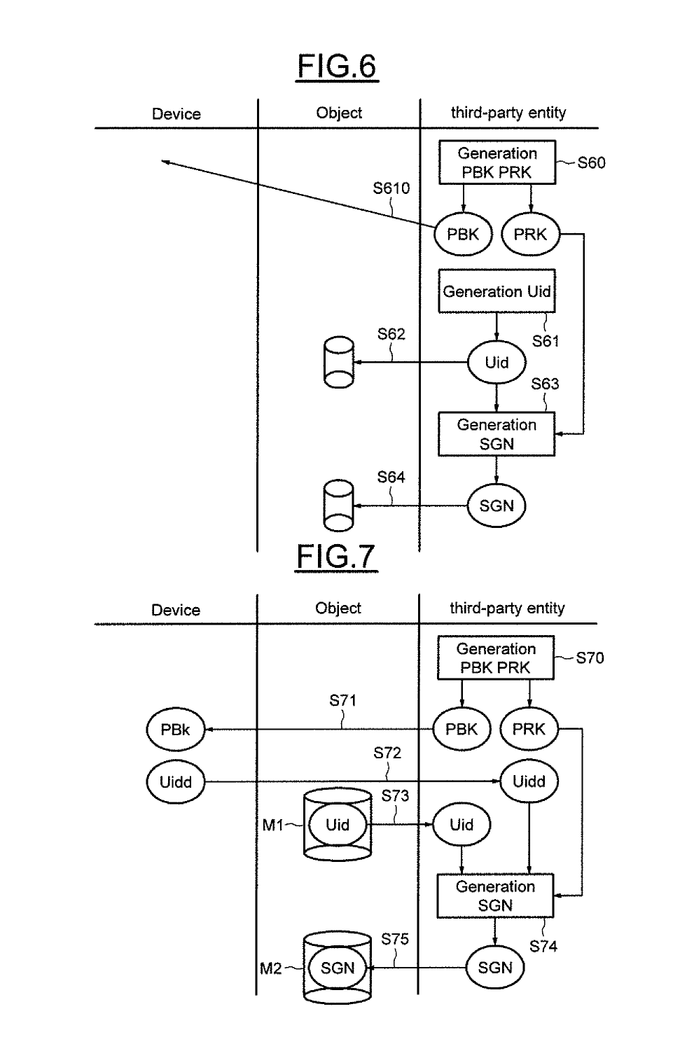

As illustrated in FIG. 6, the third-party entity generates, for example, during the fabrication of the object, a pair of associated public and private keys, respectively referenced PBK and PRK (step S60). These two keys are associated with the asymmetric encryption/decryption algorithm and are also associated, in a one-to-one correspondence manner, with the object-identifier Uid which is generated in the step S61.

The public key PBK is made available to the device (step S610). For this purpose, the key may be communicated directly to the device in order to be stored in it or else it may be stored in the “cloud” so as to be accessible by the device when the latter has knowledge of the object-identifier Uid.

The device may also store in memory a whole set of public keys PBK respectively associated with a set of different object-identifiers. The encryption means or encryption circuitry MCR of the third-party entity 3 then generate (step S63) the signature SGN by encrypting the object-identifier Uid with the private key PRK. The object-identifier Uid is then stored (step S62) in the memory Ml of the object, whereas the signature SGN is stored (step S64) in the memory M2.

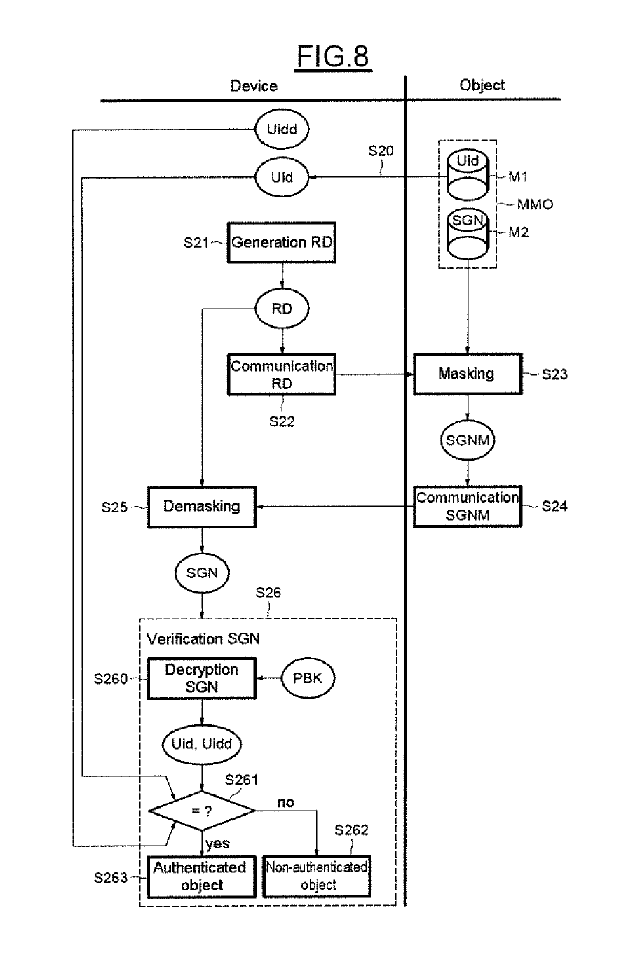

Reference is now more particularly made to FIGS. 7 and 8 in order to illustrate one application to the addition of the management of functionalities of the device by a third-party entity, typically a private controller. Thus, for example, it may be envisaged that an intelligent mobile telephone (or smart-phone) has access to a certain number of applications as long as an authenticated transponder is in contactless communications with the smart-phone. On the contrary, if the transponder is not authenticated, the telephone will only have access to restricted applications.

The transponder may, for example, be incorporated into a watch located on the wrist of the user of the mobile telephone. For this purpose, as illustrated in FIG. 7, the third-party entity generates (step S70) the pair of public PBK and private PRK keys and makes the public key PBK available (step S71) to the device.

On the other hand, the signature SGN is generated (step S74) not only from the object-identifier Uid which is communicated to the third-party entity (step S73), but also from the device-identifier Uidd which is communicated (step S72) by the device to the third-party entity. The signature SON thus obtained is stored (step S75) in the memory M2 of the object.

The authentication of the object by the device is illustrated in FIG. 8 which differs from FIG. 2 simply by the fact that, in the decryption step S260, the decryption of the signature SGN by the public key PBK supplies the object-identifier Uid and the device-identifier Uidd. Furthermore, the comparison S261 is also carried out using the device-identifier Uidd. Here again, if the two identifiers Uid and Uidd obtained by the decryption S260 correspond to the two identifiers Uidd stored in the device and Uid supplied by the object, then the object is considered as authenticated (S263) which gives complete access to the applications for the device DIS. In the opposite case, the object is non-authenticated and the device only has a restricted access to certain functionalities.

The exchanges between the object and the device for the generation of the personalized information SGNM and its communications are, for example, carried out via messages having a format conforming to the NFC data exchange format specification (NDEF) described, for example, in the document “NFC Forum NDEF 1.0 NFCForum-TS-NDEF_1.0 2006-07-24.”.

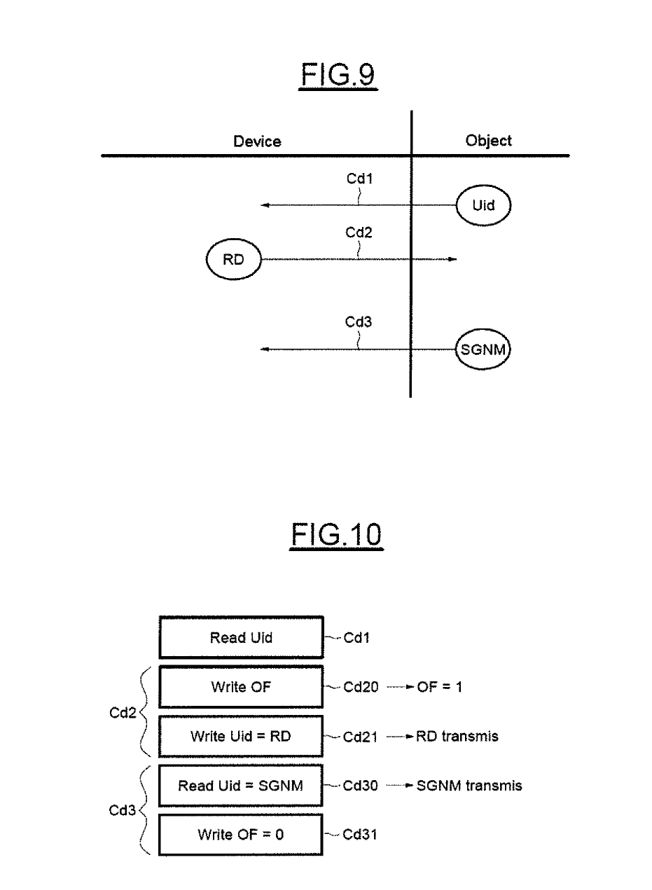

More precisely, as illustrated in FIG. 9, the communications of the object-identifier Uid is carried out by a command Cd1. The transmission of the indication RD to the object is carried out by a command Cd2 and the transmission of the personalization information, in other words the masked signature SGNM, is carried out by a command Cd3.

As illustrated in FIG. 10, in such a manner as not to create a specific command, these commands Cd1-Cd3 comprise commands for writing and reading the object-identifier Uid in which the contents of the fields dedicated to the object-identifier are, for some of these commands, modified so as to contain the indication RD or the personalized information SGNM.

However, in order for these modifications to be taken into account by the object, a parameter OF is used whose value will allow these modifications to be taken into account. More precisely, the command Cd1 is a conventional read command “Read Uid”.

The command Cd2 comprises two write commands. A first write command Cd20, “Write OF”, allows the value of the parameter OF to be fixed at 1 (for example) and this value to be stored in a temporary register of the object.

The command Cd2 then comprises a second write command Cd21, “Write Uid”, in which the field Uid contains the indication RD. Thus, when the object receives this command Cd21 and when the parameter OF is at 1, the object-processing means know that the field of this command Cd21 contains the indication RD.

Similarly, the command Cd3 comprises a first read command Cd30 followed by a write command Cd31. The read command is a command for reading the object-identifier in which the content of the identifier field has been modified so as to contain the personalization indication SGNM. The parameter OF having the value 1, the object-processing means know that they must place in the field of this read command the value of the masked signature SGNM.

Lastly, the device-processing means send a write command Cd31 “Write OF=0” which allows the value of the parameter OF to be deleted and allows it to be reset into its initial state having the logical value 0 (for example).

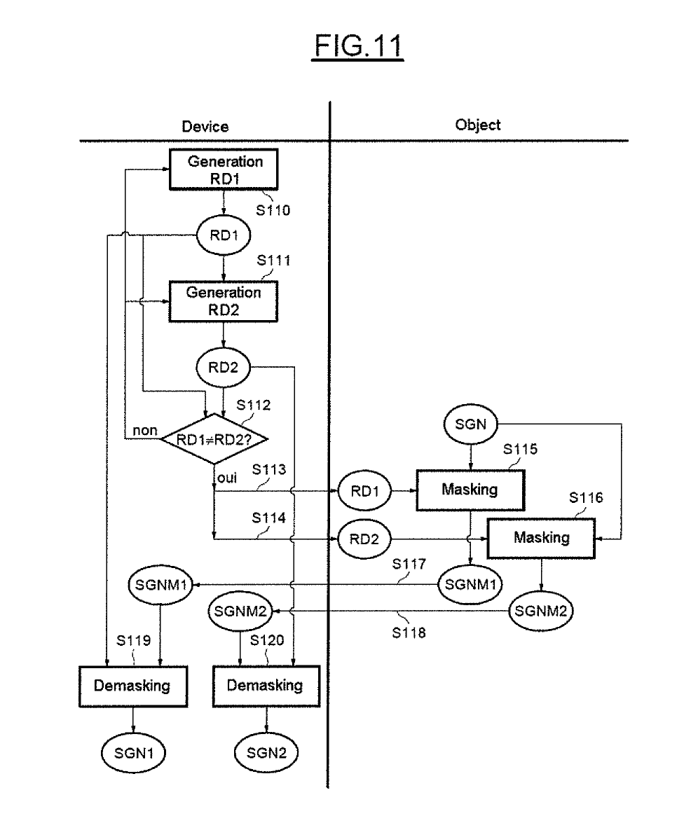

Reference is now more particularly made to FIGS. 11 to 13 in order to describe one variation using redundancy of personalization for the signature stored SGN during the authentication of the object by the device.

More precisely, as illustrated in FIG. 11, the device-processing means generate (steps S110 and S111) two pseudo-random or random numbers RD1, RD2 acting as two indications. Although the probability of obtaining two equal numbers RD1, RD2 is very low, the device-processing means verify, in the step S112, the non-equality of the numbers RD1 and RD2. In the opposite case, the device-processing means again generate at least one of the two numbers. Then, the indications RD1, RD2 are transmitted to the object (steps S113 and S114).

The object-processing means subsequently carry out, by the masking operator, a masking S115 of the signature SGN with the indication RD1 and a masking S116 of the signature SGN with the indication RD2 so as to obtain two masked signatures SGNM1 and SGNM2.

These two masked signatures SGNM1 and SGNM2 are subsequently transmitted (steps S117 and S118) to the device where the device-processing means carry out, by the de-masking operator, a de-masking of the masked signature SGNM1 and a de-masking of the masked signature SGNM2 so as to obtain two signatures SGN1 and SGN2 which are supposed to be identical and equal to the signature SGN. Of course, the order of the steps in FIG. 11 may be modified.

Thus, the step S113 could, for example, be carried out before the step S111, or else the sequence of steps S110, S113, S115, S117, S119 could first be performed, then the sequence of steps S111, S112 (in the case of equality, an indication RD2 is again generated), S114, S116, S118, S120.

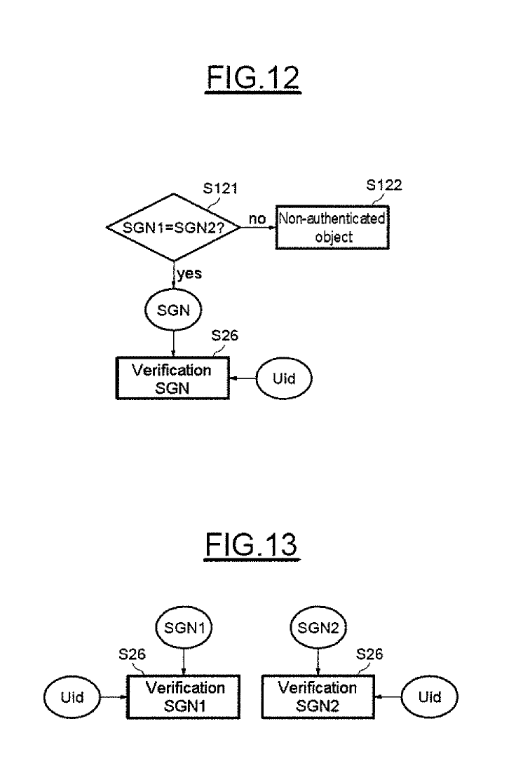

Two approaches may be subsequently envisaged for carrying out the authentication. A first approach, illustrated in FIG. 12, includes a pre-verification S121 of the equality of the de-masked signatures.

In the case of non-equality, the object is declared non-authenticated (S122). In the case of equality, the device-processing means carry out the verification of the signature SGN by taking either one of the de-masked signatures SGN1 or SGN2. This verification S26 is, for example, that as already described in FIG. 2. A second approach, illustrated in FIG. 13, carries out, for each de-masked signature SGN1, SGN2, a verification S26 according, for example, to that described in FIG. 2.

If one of the verifications fails (is negative), the object is declared non-authenticated. If all the verifications for each result in an authenticated object, then the object is declared authenticated.

1-32. (canceled)

33. A method for authentication of an object by a device, the object storing a signature associated with the object, the method comprising:
generating in the object at least one piece of personalized information of the object based on at least the stored signature and on at least one indication associated with the object and communicated without contact by the device to the object during the authentication;
contactless communicating to the device the at least one piece of personalized information;
at least one determining by the device of the signature based on at least the personalized information and on the at least one indication; and
at least one verifying of the signature by the device.

34. The method according to claim 33, wherein the at least one indication is generated by the device during the authentication.

35. The method according to claim 34, wherein generating of the at least one indication comprises generating at least one unpredictable variable.

36. The method according to claim 33, further comprising:
generating in the object a plurality of pieces of personalized information of the object based on the stored signature and on a plurality of different indications associated with the object and communicated without contact by the device to the object during the authentication;
contactless communicating to the device the plurality of pieces of personalized information; and
a plurality of determinings by the device of the signature based respectively on the plurality of pieces of personalized information and on the corresponding indications.

37. The method according to claim 36, wherein the at least one verifying of the signature by the device comprises a pre-verification of an equality of the determined signatures, and in case of an equality, verifying one of the determined signatures.

38. The method according to claim 36, wherein the at least one verifying of the signature by the device comprises verifying each of the determined signatures.

39. The method according to claim 33, wherein generating the at least one piece of personalized information comprises at least one masking of the signature by a masking operator using the at least one indication; and
the at least one determining by the device of the signature comprises at least one de-masking of the at least one masked signature, by a de-masking operator associated with the masking operator and of the at least one indication.

40. The method according to claim 33, wherein the stored signature results from an encryption of at least one object-identifier of the object with a private key of an asymmetric encryption/decryption algorithm; and
the at least one verifying of the signature comprises a decryption by the device of the at least one encrypted object-identifier, by the public key of the encryption/decryption algorithm and a comparison of a result of the decryption with the at least one object-identifier having been communicated to the device by the object.

41. The method according to claim 40, wherein generating the pair of public and private keys, making the public key available to the device, and generating the signature and storing in the object are carried out by a third-party entity.

42. The method according to claim 41, wherein generating the signature comprises an encryption of the object-identifier and of a device-identifier associated with the device with the private key of the asymmetric encryption/decryption algorithm; and
the at least one verifying of the signature comprises the decryption by the device of the object-identifier and of the encrypted device-identifier, by the public key of the encryption/decryption algorithm and a comparison of a result of the decryption with the device-identifier and with the object-identifier having been communicated without contact to the device by the object.

43. The method according to claim 33, wherein the object comprises an NFC object and the device comprises an NFC device.

44. The method according to claim 40, wherein the contactless communicating of the at least one indication by the device to the object and the contactless communicating of the at least one piece of personalized information by the object to the device comprise commands for writing and/or reading the object-identifier in which contents of the fields dedicated to the object-identifier are modified so as to respectively contain the at least one indication or the at least one piece of personalized information, with the taking into account of these modifications by the object being conditioned to a chosen value of a parameter fixed by the device.

45. A system comprising:
an object and a device both configured for contactless communications with one another;
said object comprising a memory configured to store a signature associated therewith;
said device comprising a device-processor configured to communicate to said object at least one indication associated with said object during an authentication of said object by said device-processor;
said object comprising an object-processor configured to generate at least one piece of personalized information of said object based on the stored signature and on the at least one indication, and to deliver the at least one piece of personalized information to said device; and
said device-processor further configured to carry out at least one determination of the signature based on at least the one piece of personalized information and on the at least one indication, and to perform at least one verification of the signature.

46. The system according to claim 45, wherein said device-processor comprises a generator configured to generate the at least one indication during the authentication.

47. The system according to claim 46, wherein said generator comprises a random or pseudo-random number generator, with the at least one indication comprising a random or pseudo-random number.

48. The system according to claim 45, wherein said device-processor is further configured to communicate to said object a plurality of different indications associated with said object during an authentication of said object by said device;
said object-processor is further configured to generate a plurality of pieces of personalized information of said object based on the stored signature and on the plurality of different indications, and to deliver these pieces of personalized information to said device; and
said device-processor is further configured to carry out a plurality of determinations of the signature based respectively on the plurality of pieces of personalized information and on the corresponding indications.

49. The system according to claim 48, wherein said device-processor is further configured to carry out a pre-verification of an equality of the determined signatures, and in the case of equality, a verification of one of the determined signatures.

50. The system according to claim 48, wherein said device-processor is further configured to carry out a verification of each of the determined signatures.

51. The system according to claim 45, wherein said object-processor comprises a masking operator configured to carry out at least one masking of the signature using the at least one indication so as to generate the at least one piece of personalized information; and
said device-processor comprises a de-masking operator associated with said masking operator and configured to carry out at least one de-masking of the at least one masked signature by the at least one indication so as to carry out at least one determination of the signature.

52. The system according to claim 45, wherein the stored signature results from an encryption of at least one object-identifier of said object with a private key of an asymmetric encryption/decryption algorithm;
said object-processor is further configured to communicate to said device the at least one object-identifier; and
said device-processor is further configured to verify the signature comprising the encryption/decryption algorithm to carry out a decryption of the at least one encrypted object-identifier, by the public key, said device-processor comprising a comparator to carry out a comparison of a result of the decryption with the at least one object-identifier having been communicated to the device by the object.

53. The system according to claim 52, further comprising a third-party entity configured to generate the pair of public and private keys, to make the public key available to said device, and to generate the signature and store in said object.

54. The system according to claim 53, wherein said third-party entity is configured to generate the signature by an encryption of the object-identifier and of a device-identifier associated with said device with the private key of the asymmetric encryption/decryption algorithm, and the encryption/decryption algorithm associated with the verification are able to decrypt the object-identifier and the encrypted device-identifier, by the public key and a comparison of a result of the decryption with the device-identifier and with the object-identifier having been communicated to said device by said object.

55. The system according to claims 45 to 22, wherein said object comprises an NFC object and said device comprises an NFC device.

56. The system according to claim 52, wherein said memory of said object is further configured to store a parameter;
said device-processor is further configured to generate commands for writing and/or reading the object-identifier in which contents of the fields dedicated to the object-identifier are modified so as to respectively contain the at least one indication or the at least one piece of personalized information, and to set a value of the parameter to a chosen value; and
said object-processor is further configured to take into account the modifications of the contents of the fields when a value of the parameter has the chosen value.

57. An object for contactless communications with a device, and comprising:
a memory configured to store a signature associated with the object;
an object-processor configured to generate at least one piece of personalized information for the object based on at least the stored signature and on at least one indication associated with the object communicated by the device to the object during an authentication of the object by the device, and to deliver at least the personalized information to the device.

58. The object according to claim 57, wherein said object-processor comprises a masking operator configured to carry out at least one masking of the signature using the at least one indication so as to generate the at least one piece of personalized information.

59. The object according to claims 57, wherein the stored signature results from an encryption of at least one object-identifier of the object with a private key of an asymmetric encryption/decryption algorithm; and
said object-processor is further configured to communicate to the device the at least one object-identifier.

60. The object according to claim 57, wherein said memory and said object-processor are configured to operate as a transponder.

61. The object according to claim 57, wherein said memory and said object-processor are configured to support near field communications.

62. The object according to claim 57, wherein said memory is further configured to store a parameter; and said object-processor is further configured to receive commands for writing and/or reading the object-identifier in which contents of fields dedicated to the object-identifier are modified so as to respectively contain the at least one indication or the at least one piece of personalized information, and so as to take into account modifications of the contents of the fields when a value of the parameter has a chosen value.
